(19) United States
(12) Patent Application Publication
(10) Pub. No.: US 2011/0192266 A1
(43) Pub. Date: Aug. 11, 2011

(54) Cutting Tool and Method for Treating Surface Thereof

(75) Inventors: Jong Sung Kim, Daegu (KR); Si Hoon Song, Daegu (KR)

(73) Assignee: TaeguTec, Ltd., Dalsung-gun (KR)

(21) Appl. No.: 13/089,753

(22) Filed: Apr. 19, 2011

Related U.S. Application Data
(63) Continuation-in-part of application No. PCT/KR2008/006273, filed on Oct. 23, 2008.

(30) Foreign Application Priority Data
Oct. 21, 2008 (KR) 10-2008-0103166

(51) Int. Cl. B26D 1/00; B24C 1/00

(52) U.S. Cl. 83/651; 451/38

(57) ABSTRACT

A method for treating a surface of a cutting tool includes first blasting the surface of the cutting tool using a granular abrasive and then brushing the blasted surface of the cutting tool. The surface condition of the cutting tool is improved, thereby achieving superior resistance to chipping while cutting a workpiece and excellent durability by means of improvement in abrasion resistance and toughness.

### RELATED APPLICATIONS

This is a Continuation-in-part of PCT/KR2008/006273, filed 23 Oct. 2008 and published as WO 2010/047431A1, which in turn claims priority to KR 10-2008-0103166, filed 21 Oct. 2008. The contents of the aforementioned applications are incorporated by reference in their entirety

### FIELD OF THE INVENTION

The present invention generally relates to cutting tools and a method for treating a surface thereof, and more particularly, to a cutting tool and a method for treating a surface thereof, in which the surface (a coating layer) of the cutting tool is primarily blasted and then secondarily brushed so that the cutting tool has superior resistance to chipping while cutting a workpiece, and superior durability through improvement in abrasion resistance and toughness.

### BACKGROUND

A cutting tool is used to process cast iron, carbon steel, alloy steel, etc. The cutting tool, such as an insert, performs cutting when in contact with a workpiece. Generally, a cutting tool, e.g. an insert, uses a cemented carbide, made by mixing cobalt (Co) with tungsten carbide (WC) and sintering the mixture, or a Ti-group carbo-nitride cermet, as its base material which has a hard coating layer for abrasion resistance formed on its surface. The coating layer is formed by coating a compound such as a metallic oxide (e.g., Al2O3), a carbide (e.g., TiC), and the like using a chemical vapor deposition (CVD) method or a physical vapor deposition (PVD) method.

For example, U.S. Pat. No. 6,007,909 suggests a cutting tool in which a coating layer having a thickness of 1-20 μm is formed on a Ti-group carbo-nitride cermet base material, and U.S. Pat. No. 6,183,846 suggests a cutting tool where an inner layer with a thickness of 0.1-5 μm, consisting of a carbide, a nitride, a carbo-nitride, a carbo-oxide, a carbonitrogen oxide or a boronitride of Ti, an intermediate layer with a thickness of 5-50 μm, consisting of Al₂O₃, and an outer layer with a thickness of 5-100 μm, consisting of a carbide, a nitride, a carbo-nitride, a carbo-oxide, a carbonitrogen oxide or a boronitride of Ti are formed on a surface of a cemented carbide or cermet base material. Korean Patent Registration No. 0847715 suggests a cutting insert including a coating layer where a single layer of a carbide, a nitride, or an oxide, a multi-layer thereof, and/or a crossed layer thereof are injected on a cermet base material including a Co and/or Ni binder phase. Korean Patent Publication No. 10-2004-0084760 discloses a coated cutting insert where a TiCₓN_{y}O_{z} layer (0.7≦x+y+z≦1) and an Al₂O₃ layer are formed on a cemented carbide base material.

The coating layer is formed by injecting crystalline particles, and some of the particles protrude, resulting in an uneven surface. Consequently, the outermost surface of the cutting tool becomes rough due to the formation of pointed protrusions. Such a phenomenon becomes more severe as the thickness of the coating layer increases. The phenomenon is particularly severe in ceramic coatings such as Al₂O₃. Moreover, this phenomenon is common in coating layers regardless of the type of material forming the coating layers. A cutting tool having a rough surface is subjected to non-uniform stress while cutting a workpiece, and as a result chipping is likely to occur at the cutting portion and the coating layer or the base material may be damaged, causing the effectiveness of the tool to be reduced.

In order to improve the rough surface of cutting tools, a technique for performing surface treatment on the coating layer has been attempted. For example, Korean Patent Registration No. 0187564 discloses a surface treatment method in which a surface (coating layer) of a coated cutting tool is rubbed with an abrasive cloth or brush-honed.

However, the disclosed surface treatment methods above may provide an even surface to some extent, but the provided surface has poor resistance to chipping, low abrasion resistance, and low toughness because it is not sufficiently smooth and flat.
[Prior Patent Document 1] U.S. Pat. No. 6,007,909
[Prior Patent Document 2] U.S. Pat. No. 6,183,846
[Prior Patent Document 3] Korean Patent Registration No. 0847715
[Prior Patent Document 4] Korean Patent Publication No. 10-2004-0084760
[Prior Patent Document 5] Korean Patent Registration No. 0187564

It is the object of the present invention to solve the foregoing problems of the prior art and to provide a method for treating a surface of a cutting tool so it has superior resistance to chipping while cutting a workpiece, and has superior durability through improvement of abrasion resistance and toughness. The present invention also provides a cutting tool whose surface is treated using the above method.

In order to achieve the foregoing object, the present invention provides a method for treating a surface of a cutting tool, comprising blasting the surface of the cutting tool using a granular abrasive and brushing the blasted surface of the cutting tool.

The abrasive may be comprised of one or more materials selected from a group consisting of mineral particles, ceramic particles, and metal particles. According to a preferred embodiment of the present invention, the blasting may be performed by injecting the abrasive onto the surface of the cutting tool at a pressure of 1.0-2.5 bar for 5-30 seconds. The blasting may also be performed by injecting a mixture of the granular abrasive and water onto the surface of the cutting tool. Preferably, the abrasive has a density of 0.8-1.5 kg/l.

The brushing may be performed for 50-200 seconds while either one or both a brush and the cutting tool is being rotated at a speed of 60-120 rpm. Preferably, a lubricant is applied to the brush. The lubricant may include solid particles having a size of 0.5-10 μm.

Moreover, the present invention also provides a cutting tool whose surface is treated by the method.

According to the present invention, the surface condition of the cutting tool is improved by a two-step surface treatment including blasting (primary surface treatment) and brushing (secondary surface treatment). Therefore, the cutting tool has superior resistance to chipping while cutting a workpiece and has excellent durability by means of improvement in abrasion resistance and toughness. Moreover, the surface treatment time for producing equivalent surface quality is remarkably reduced compared to other conventional surface treatment methods.

### BRIEF DESCRIPTION OF THE DRAWINGS

FIG. 1 is an exemplary perspective view of a brushing device used in the present invention.

FIGS. 2 and 3 illustrate enlarged pictures of surfaces of corner portions of cutting tool specimens which are surface-treated according to comparison examples and an embodiment of the present invention.

FIGS. 4 and 5 illustrate enlarged pictures of surfaces of crater portions of the cutting tool specimens which are surface-treated according to the comparison examples and the embodiment of the present invention.

FIGS. 6 and 7 illustrate enlarged pictures of surfaces of grinding portions of the cutting tool specimens which are surface-treated according to the comparison examples and the embodiment of the present invention.

FIG. 8 illustrates cross-sectional pictures of surfaces of the cutting inserts according to comparison examples 5 and 6.

FIG. 9 illustrates pictures of surfaces of a workpiece cut by using the cutting tool specimens which are surface-treated according to the embodiment of the present invention.

FIG. 10 illustrates measurement standards for surface roughness of the workpieces according to the present invention.

### DETAILED DESCRIPTION

Hereinafter, the present invention will be described in more detail.

In the present invention, a cutting tool which is subject to surface treatment is typically a cutting insert mounted on a tool holder. A cutting tool contacts a workpiece such as cast iron, carbon steel, alloy steel, etc., and includes a hard coating layer coated onto a base material for abrasion resistance. The base material and the coating layer include commonly used materials. For example, the base material may be selected from cemented carbide made by mixing cobalt (Co) with tungsten carbide (WC) and sintering the mixture, and a cermet including a Ti-group carbo-nitride phase, or Co, Ni, W and/or Mo. The cermet may include one or more additional elements selected from Ta, Nb, V, Zr, Hf, Cr, and the like.

The coating layer may be coated onto a surface of the base material by means of chemical vapor deposition (CVD) or physical vapor deposition (PVD), and may include an oxide, a carbide, a nitride, a carbo-nitride, a nitric oxide, or a nitride carbonate including one or more elements selected from Al, Ti, Zr, and Hf, or a mixture thereof. More specifically, for example, the coating layer may include one or more coatings selected from α-Al₂O₃, (alpha Al₂O₃), TiN, AlOₓN_{y} (0≦x≦1, 0≦y≦1), HfN, TiCₓN_{y} (0≦x≦1, 0≦y≦1), and TiCₓN_{y}O_{z} (0≦x≦1, 0≦y≦1, 0≦z≦1). The coating layer may be a single layer or a multi-layer including two or more layers. Although it is not particularly limited, in the case of a multi-layer coating layer, the coating layer includes, for example, a TiN layer formed on the surface of the base material and the α-Al₂O₃ layer formed on the TiN layer, in which the α-Al₂O₃ layer is the outermost layer. The thickness of the coating layer may be 3.0-50 μm, but is preferably 10-30 μm. The coating layer is etched by a method for treating a surface of a cutting tool (blasting and brushing) according to the present invention as described below, preferably with an etching thickness of 0.5-2.0 μm.

The method for treating the surface of the cutting tool according to the present invention includes at least a primary surface treatment step of blasting the surface of the cutting tool, i.e., a surface of the coating layer (outermost layer), and a secondary surface treatment step of brushing the blasted surface of the cutting tool. The blasting step (primary surface treatment) and the brushing step (secondary surface treatment) are consecutively performed. That is, the surface (coating layer) of the cutting tool is primarily blasted, after which the blasted surface is secondarily brushed.

In the present invention, the blasting step is performed by injecting a granular abrasive onto the surface (coating layer) of the cutting tool at high pressure and may include a dry method and a wet method. More specifically, the blasting step may be carried out by a dry method in which the granular abrasive is injected onto the surface of the cutting tool by using high-pressure air as a propellant or by a wet method in which a mixture of the granular abrasive and water is injected onto the surface of the cutting tool at high pressure. Preferably, the blasting step is conducted by the wet method because it is advantageous in terms of work environment, roughness, and uniformity. The abrasive may be one species or a mixture of at least two species selected from a group consisting of mineral particles (natural sand, silica, etc.), ceramic particles (alumina particles, etc.), metal particles (cast iron, alloy steel particles, etc.), and the like.

The size of the granular abrasive particles (grain size distribution) is preferably 30 μm-900 μm. If the abrasive particles are too small, e.g., their size is less than 30 μm, good flatness cannot be expected and too much time is taken to process the tool. On the other hand, if the abrasive particles are too large, e.g., their size exceeds 900 μm, surface roughness may become severe and the coating layer may be cracked or damaged. The cutting tool, such as an insert, has protruding portions (corners, edge portions, and the like), which may be disadvantageously etched if the abrasive is large in size. Moreover, the granular abrasive may be a mixture of small-diameter particles of 30-75 μm and large-diameter particles of 75-900 μm at a ratio of 1:0.5-2.

When the blasting step is performed by the wet method, the density of the abrasive is preferably 1.0-1.5 kg/1 (quantity of the abrasive included in a 1 l mixture of the abrasive and water). The abrasion efficiency may be reduced and too much time may be taken to process the tool if the abrasive density is less than 1.0 kg/l, whereas superior injection cannot be expected if the abrasive density exceeds 1.5 kg/l. The density of the abrasive is preferably 1.0-1.2 kg/l.

For the wet blasting step, the injection pressure of the abrasive is preferably 1.0-2.5 bar, and more preferably 1.4-2.0 bar. If the injection pressure is less than 1.0 bar, it is difficult to perform etching. On the other hand, if the injection pressure exceeds 2.5 bar, the etch rate increases, thereby removing the coating layer or causing damage to the coating layer. Under such pressure conditions, the blasting step (abrasive injection at high pressure) is preferably performed for 5-30 seconds. For example, in the case of a commonly used CNMG 12-type cutting insert, it is desirable to perform the blasting step for 10-15 seconds at an injection pressure of 1.4-2.0 bar.

The blasting step is performed by injecting the abrasive onto a plurality of cutting tools arranged on a conveyer, from a blasting gun installed at a predetermined angle on the conveyer, where the conveyor moves horizontally (in an x direction on an x-y plane) and the blasting gun repetitively moves vertically (in a y direction on the x-y plane). The conveyor speed is preferably 120-200 mm/min. The etching is too excessive for a conveyor speed less than 120 mm/min, but the etching is insufficient for a conveyor speed exceeding 200 mm/min. The blasting gun may repetitively move at a speed of 4500-5500 mm/min. In other words, the cutting tools move horizontally (in an x direction on an x-y plane) at the conveyor speed of 120-200 mm/min, while a blasting gun installed above the conveyor repetitively moves vertically (in a y direction on the x-y plane) at the speed of 4500-5500 mm/min. By performing the blasting step under such operating conditions, excellent flatness can be achieved. The injection may be performed with the blasting-gun at an angle in the range of 45±20 degrees. By injecting the abrasive in such a way, a top surface and a side surface of the cutting tool can be uniformly blasted. Thereafter, the cutting tool is turned over to blast a bottom surface of the cutting tool.

When the blasting step is performed by the dry method, the injection pressure of the air and the abrasive is preferably 1.0-2.5 bar, and more preferably 1.8-2.0 bar. Under such pressure conditions, the blasting step is preferably performed for 5-30 seconds. The conveyor speed is preferably 150-500 mm/min. If the injection pressure is too low or the conveyor moves too slowly, it is difficult to perform etching. On the other hand, if the injection pressure is too high or the conveyor moves too fast, the etch rate becomes excessive, thereby removing the coating layer or causing damage to the coating layer to an unacceptable extent.

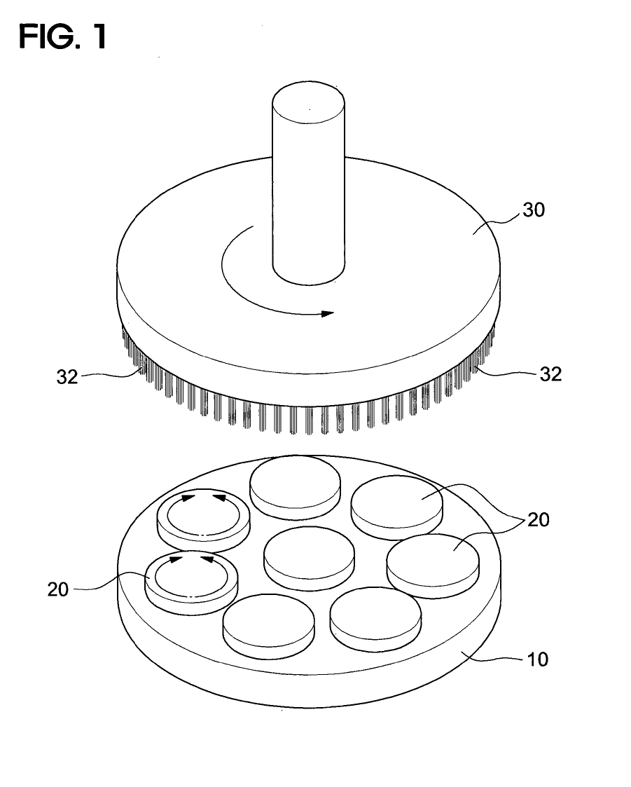

The brushing step may be performed by a general brushing method (brush honing). The brushing step may be carried out by using a brushing device as illustrated in FIG. 1. Although the brushing step may be performed by rotating at least one of a brush and the cutting insert by using the brushing device described below, it is desirable to perform the brushing step by simultaneously rotating both the brush and the cutting insert.

Referring to FIG. 1, the brushing device includes a support plate 10, and a disc-shaped carrier 20 installed on the support plate 10. A plurality of carriers 20 may be installed on the support plate 10 and rotate clockwise (forward rotation) and/or counterclockwise (reverse rotation). FIG. 1 illustrates a state where eight (8) carriers 20 installed on the support plate 10 rotate clockwise and counterclockwise. A plurality of cutting inserts is mounted on the carrier 20. For example, 36 cutting inserts may be mounted on one carrier 20. The brushing device also includes a disc-shaped brush plate 30 installed above the carrier 20. A plurality of brushes 32 are arranged under the brush plate 30. The brush plate 30 may have a diameter of 500 mm, and the carrier 20 may have a diameter of 138 mm. The brush plate 30 is rotatably installed, and is preferably installed so as to rotate counterclockwise (reverse rotation) as well as clockwise (forward rotation). For example, the carrier 20 may repeat rotation clockwise (forward rotation) and counterclockwise (reverse rotation) and the brush plate 30 installed above the carrier 20 may rotate in one direction (e.g., clockwise), thereby improving brushing efficiency.

In a preferred embodiment, a lubricant is applied to the brush 32 for efficient brushing. The lubricant is preferably a paste-phase composition including oil and solid particles (abrasive). For example, the solid particles may be silica or diamond. The solid particles may have a size of 0.5-10 μm. The solid particles may be included in the paste-phase lubricant by 0.2-5 weight %, e.g., 2-50 g of solid particles are mixed with 1 kg of a lubricant.

The brushing step may be performed by rotating the brush 32 at a speed of 60-120 rpm. In other words, the rotation speed of the brush plate 30 is 60-120 rpm. If the rotation speed of the brush 32 is less than 60 rpm, too much time is taken to smooth the surface, whereas if the rotation speed of the brush exceeds 120 rpm, the brush 32 may be prematurely worn out. The brushing step is preferably performed for 50-200 seconds at the rotation speed of the brush 32. It is difficult to obtain a smooth surface with a brushing time less than 50 seconds. On the other hand, with a brushing time exceeding 200 seconds, the surface becomes smooth but leads to excessive abrasion of the coating layer due to brushing and too much power may be required. It is preferable that the carrier 20 installed under the brush plate 30 repeat forward rotation and reverse rotation during rotation of the brush plate 30 where the carrier 20 rotates forward once for 25-100 seconds and then rotates in reverse once for 25-100 seconds. The rotation speed of the carrier 20, i.e., the rotation speed of the cutting tool is preferably 60-120 rpm.

According to the present invention, the surface condition of the cutting tool is improved by the above-described two-step consecutive surface treatments (blasting and brushing). More specifically, the flatness (roughness) of the surface of the cutting tool is improved by primary blasting, and the blasted surface becomes smooth by secondary brushing performed after primary blasting. If only blasting is performed, the flatness may be improved, but the surface is not smooth. If only brushing is performed, the surface becomes smooth, but the flatness is reduced and too much time is taken. Here, if the surface is treated for a long time to achieve an equivalent flatness with only brushing, there is the problem of removing the outer coating layer due to excessive etching. If brushing is performed and then blasting is performed, a smooth surface cannot be obtained. Therefore, blasting is performed first and then brushing is performed. By doing so, the surface condition of the cutting tool is improved, thereby manufacturing a cutting tool having superior resistance to chipping while cutting a workpiece and having excellent durability through improvement of abrasion resistance and toughness. In addition, the treatment time required for an improved surface can be remarkably reduced and the surface quality such as surface roughness is much improved. The cutting tool is generally used while inserted into a cutting tool holder. According to the present invention, close contact with the holder is enhanced by surface improvement, thereby preventing damage to the cutting tool or the holder.

Hereinafter, embodiments of the present invention will be described in further detail.

The following embodiments are provided only to facilitate understanding of the present invention and do not limit the technical scope of the present invention.

### Embodiments 1-3

A commonly used CNMG 12-type cutting insert, having an Al₂O₃ layer of 15 μm coated on a cemented carbide base material, was used as a target specimen on which wet sand blasting and brushing were consecutively performed.

Wet Sand Blasting

By using a wet sand blasting device, a surface of the cutting insert (CNMG 12-type) was wet-sand-blasted under the conditions shown in Table 1. As an abrasive, alumina particles of a Treibather Company product known as ALODUR® were used in the form of a mixture of alumina particles of 170 mesh (90 μm) and those of 230 mesh (63 μm) at a weight ratio of 1:1. The density of the abrasive was 1.01 kg/l (quantity of alumina included in a 1 l mixture of alumina and water).

TABLE 1
<Wet Sand Blasting Conditions>

| | | Embodi- | Embodi- | Embodi- |
|---|---|---|---|---|
| Parameter | Unit | ment 1 | ment 2 | ment 3 |
| Blasting pressure gun | Bar | 1.4 | 1.8 | 2.5 |
| Speed of gun-motion | mm/min | 5000 | 4500 | 4500 |
| Speed of conveyor | mm/min | 150 | 150 | 150 |
| Angle of blasting gun | degree | 45° | 45° | 45° |
| Density of sand | kg/l | 1.01 | 1.01 | 1.01 |
| Blasting time | sec | 12 | 12 | 12 |

Brushing

The wet-sand-blasted specimen was brushed by using a brushing device under the conditions shown in Table 2. The brushing device has a structure as illustrated in FIG. 1. The diameter of the carrier 20 was 138 mm and the diameter of the brush plate 30 was 500 mm. In Embodiment 1, the carrier 20 rotated forward once for 50 seconds and then rotated in reverse once for 50 seconds. The brush plate 30 rotated forward, and the brush 32 had a depth of 0.6 mm.

TABLE 2
<Brushing Conditions>

| | Carrier Forward | Carrier Reverse | No. of Changes between | Brush | Brush Rotation |
|---|---|---|---|---|---|
| | Rotation | Rotation | Forward/Reverse | Depth | Speed |
| | (sec) | (sec) | Rotations | (mm) | (rpm) |
| Embodiment 1 | 50 | 50 | 1 | 0.6 | 85 |
| Embodiment 2 | 40 | 40 | 1 | 0.6 | 105 |
| Embodiment 3 | 60 | 60 | 1 | 0.6 | 75 |

### Comparison Example 1

A commonly used CNMG 12-type cutting insert, having an Al₂O₃ layer of 15 μm coated on a cemented carbide base material, was used as a target specimen for Comparison Example 1, whereby a coating surface is neither blasted nor brushed (not treated).

### Comparison Example 2

A commonly used CNMG 12-type cutting insert, having an Al₂O₃ layer of 15 μm coated on a cemented carbide base material, was used as a target specimen for Comparison Example 2, whereby the coating surface is brushed only (not wet-sand-blasted) in the same manner as in Embodiment 1. Brushing time was 100 seconds with forward rotation of 50 seconds and reverse rotation of 50 seconds.

### Comparison Example 3

A commonly used CNMG 12-type cutting insert, having an Al₂O₃ layer of 15 μm coated on a cemented carbide base material, was used as a target specimen for Comparison Example 3, whereby the coating surface is wet-sand-blasted only (not brushed) in the same manner as in Embodiment 1.

### Comparison Example 4

The specimen of this Comparison Example was the same as in Embodiment 1, except that brushing was performed first, and then blasting followed.

### Comparison Example 5

The specimen of this Comparison Example was the same as in Comparison Example 2, except that brushing was performed for 300 seconds with forward rotation of 150 seconds and reverse rotation of 150 seconds.

### Comparison Example 6

The specimen of this Comparison Example was the same as in Comparison Example 2, except that brushing was performed for 500 seconds with forward rotation of 250 seconds and reverse rotation of 250 seconds.

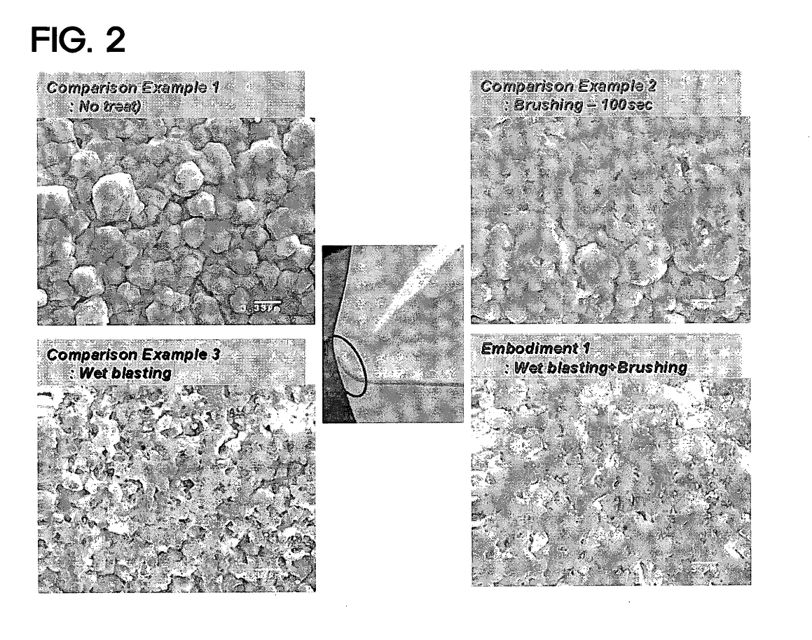

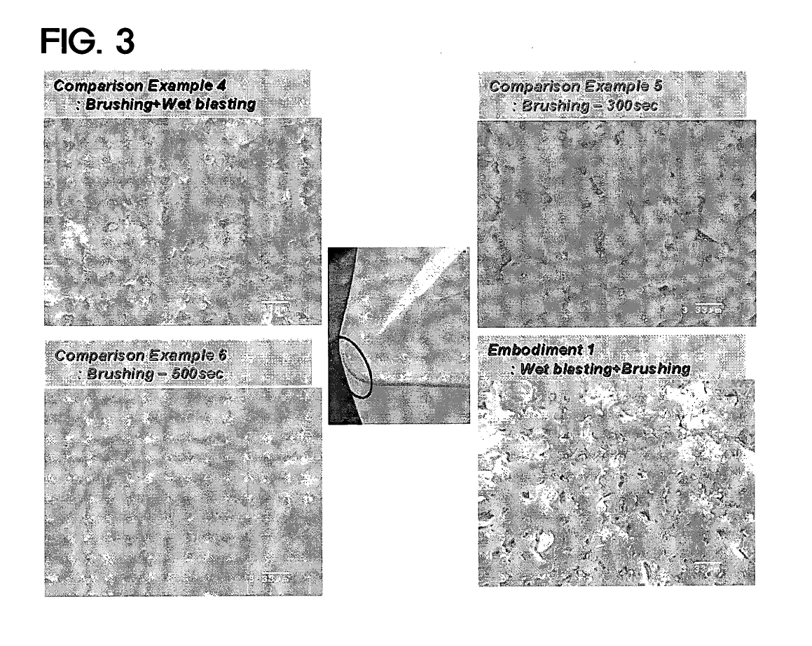

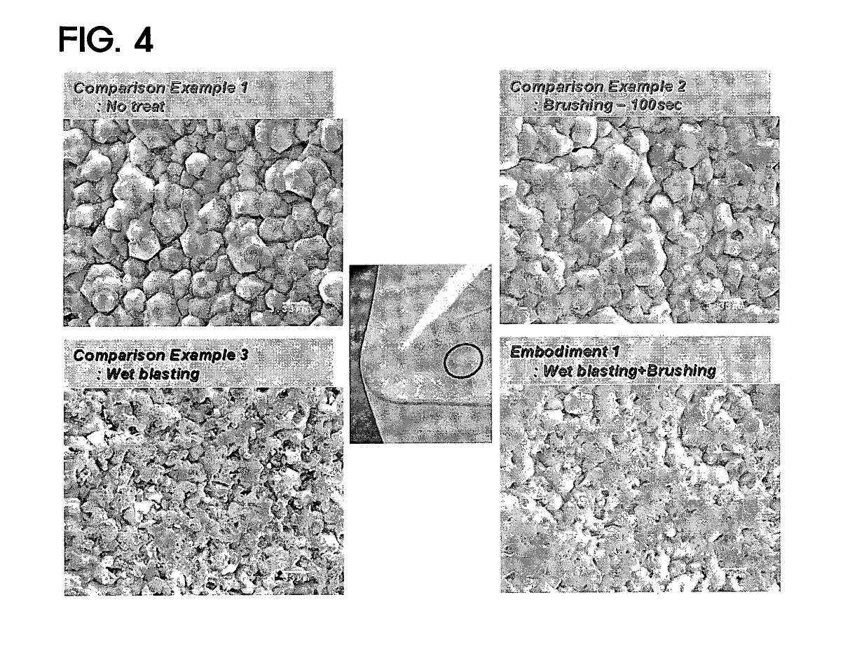

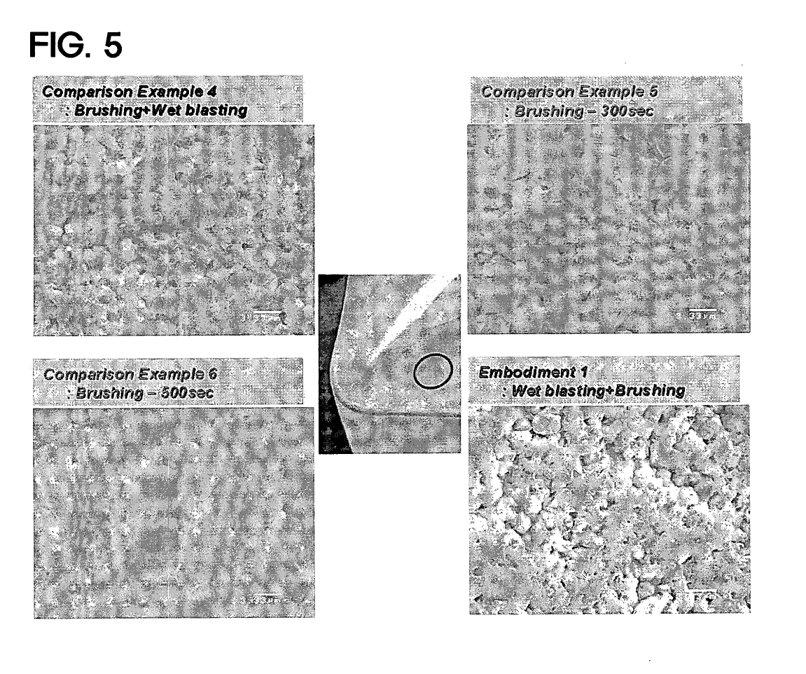

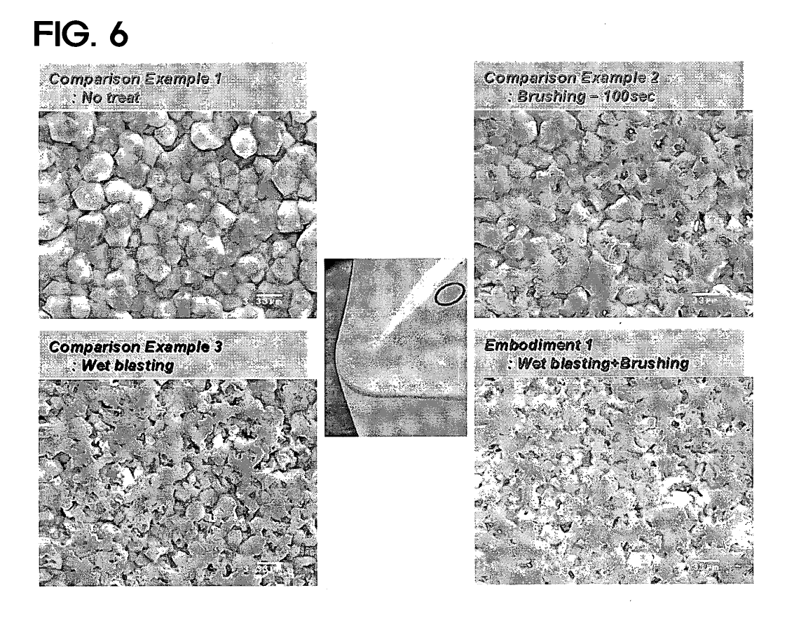

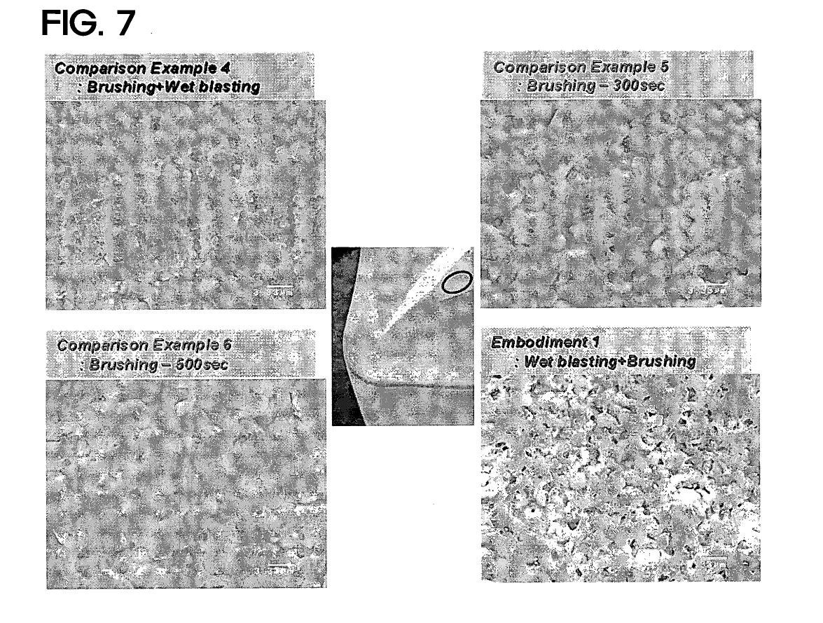

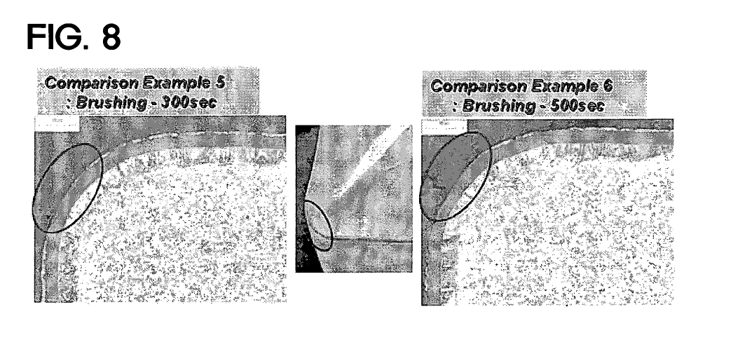

Pictures of surfaces of the specimens according to Embodiment 1 and Comparison Examples 1 6 are illustrated in FIGS. 2 through 7. FIGS. 2 and 3 illustrate enlarged pictures (×3000) of surfaces of corner portions of the specimens, FIGS. 4 and 5 illustrate enlarged pictures (×3000) of surfaces of crater portions of the specimens, and FIGS. 6 and 7 illustrate enlarged pictures (×3000) of surfaces of grinding portions of the specimens. FIG. 8 is a cross-sectional picture of Comparison Examples 5 and 6.

As illustrated in FIGS. 2 through 7, Embodiment 1 which received blasting and brushing consecutively performed according to the present invention provides a smooth surface and with superior-flatness (roughness) when compared to Comparison Example 1 where no treatment was performed, Comparison Example 2 where only brushing was performed for 100 seconds, Comparison Example 3 where only wet-sand blasting was performed, and Comparison Example 4 where brushing was performed first and then blasting was performed. In Comparison Examples 5 and 6, when only brushing was performed for longer periods for the purpose of obtaining improved surface quality, there was a problem of the coating layers being removed by excessive etching, particularly on the edge portions, due to a longer treatment time as shown in FIG. 8.

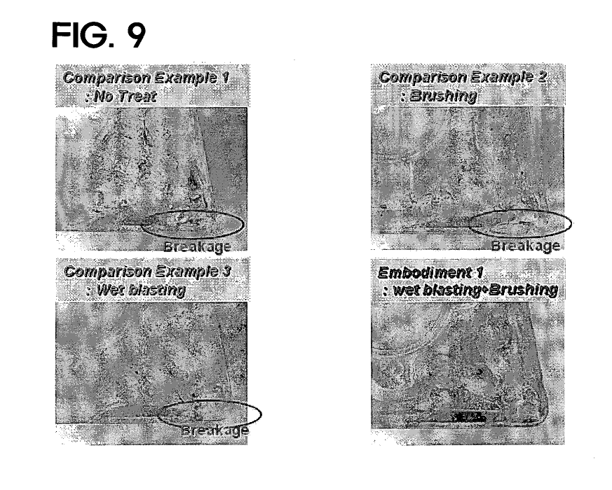

By using the specimens according to Embodiment 1 and Comparison Examples 1-6, cutting performance was evaluated using an automobile brake drum (HB 170) as a workpiece. The cutting performance was evaluated by counting the number (pcs) of workpieces processed until failure of the specimen occurred. The evaluation results, together with the cutting conditions, are shown in Table 3. FIG. 9 illustrates pictures of the workpiece after failure.

TABLE 3
<Cutting Performance Evaluation Results>

| | Number of | |
|---|---|---|
| | processed | |
| | workpieces (pcs) | Cutting conditions |
| Comparison Example 1 | 140 | Workpiece: Automobile |
| (no treatment) | | brake drum (HB 170) |
| Comparison Example 2 | 146 | Cutting conditions: V = |
| (only brushing for 100 sec) | | 50, f = 0.3, d = 2.0, Dry |
| Comparison Example 3 | 147 | |
| (only wet blasting) | | |
| Comparison Example 4 | 155 | |
| (Brushing + Blasting) | | |
| Comparison Example 5 | 150 | |
| (Only Brushing for 300 sec) | | |
| Comparison Example 6 | 145 | |
| (Only Brushing for 500 sec) | | |
| Embodiment 1 | 172 | |
| (wet blasting + brushing) | | |

As shown in Table 3 and FIG. 9, Embodiment 1, where blasting and brushing were consecutively performed according to the present invention, provides improved abrasion resistance and toughness (durability) when compared to Comparison Example 1 where no treatment is received, Comparison Example 2 where only brushing was performed, Comparison Example 3 where only wet-sand blasting was performed, Comparison Example 4 where brushing was performed first and then blasting was performed, and Comparison Examples 5 and 6 where only brushing was performed for longer periods of time, thereby preventing breakage even when more workpieces were processed. When comparing Comparison Examples 2, 5, and 6 where only brushing was performed, as shown in FIGS. 2 through 7 and Table 3, although the surface roughness improved as brushing time increased, when brushing is performed for a longer period of time in excess of 200 seconds, cutting performance measured by the number of processed workpieces deteriorated due to abrasion concentrated on the protruded portions, thereby removing the coating layer on the cutting edges.

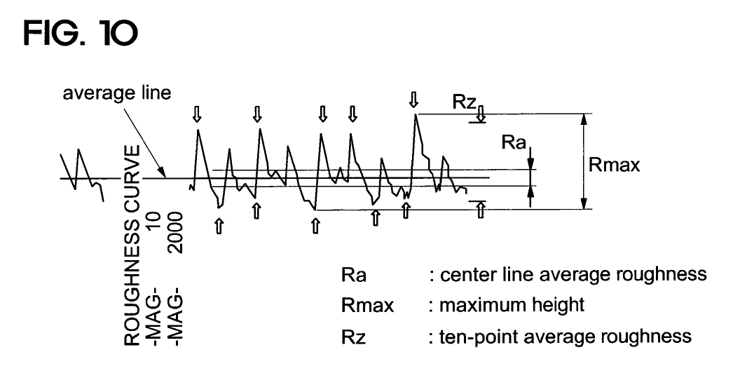

Table 4 below shows the measured surface roughness of the workpieces, which were cut by insert specimens prepared in Embodiment 1 and Comparison Examples 2 through 4. FIG. 10 illustrates measurement standards for surface roughness. In Table 4, Ra indicates a center line average roughness, Rmax indicates a maximum height, and Rz indicates a ten-point average roughness (see FIG. 10).

TABLE 4
<Surface Roughness Measured for Workpiece (HB 170)>

| | Ra | Rmax | Rz |
|---|---|---|---|
| Comparison Example 1 | 3.06 | 28.21 | 21.46 |
| (no treatment) | | | |
| Comparison Example 2 | 3.06 | 19.42 | 16.03 |
| (only brushing) | | | |
| Comparison Example 3 | 2.32 | 15.36 | 13.15 |
| (only wet blasting) | | | |
| Comparison Example 4 | 2.25 | 15.20 | 13.02 |
| (Brushing + Wet blasting) | | | |
| Embodiment 1 | 2.10 | 14.80 | 12.87 |
| (wet blasting + brushing) | | | |

As shown in Table 4, Embodiment 1, where blasting and brushing were consecutively performed according to the present invention, provides improved surface roughness of the workpieces when compared to Comparison Example 1 where no treatment is received, Comparison Example 2 where only brushing was performed, Comparison Example 3 where only wet-sand blasting was performed, and Comparison Example 4 where brushing was performed first and then blasting was performed. In addition, Table 4 indicates that the surface roughness of the workpieces finished by Comparison Example 3 where only wet-sand blasting was performed is much improved compared with that of Comparison Example 2 where only brushing was performed. This result implies that performing sand blasting, regardless of whether brushing is performed, is a decisive contributing factor for the cutting tool performance evaluated by the surface roughness of the workpieces finished by the cutting tool.

What is claimed is:

1. A method for treating a surface of a cutting tool, the method comprising:
blasting the surface of the cutting tool using a granular abrasive; and
after blasting, brushing the blasted surface of the cutting tool.

2. The method of claim 1, wherein the cutting tool includes a coating layer coated onto a base material.

3. The method of claim 1, wherein the abrasive is one or more selected from the group consisting of mineral particles, ceramic particles, and metal particles.

4. The method of claim 1, wherein particle sizes of the abrasive are between 30-900 μm.

5. The method of claim 1, wherein the blasting is performed by injecting the abrasive onto the surface of the cutting tool at a pressure of 1.0-2.5 bar.

6. The method of claim 1, wherein the blasting is performed by injecting a mixture of the abrasive and water onto the surface of the cutting tool.

7. The method of claim 6, wherein the abrasive has a density of 0.8-1.5 kg/l.

8. The method of claim 1, wherein the brushing is performed for 50-200 seconds while either one or both of a brush and the cutting tool is being rotated at a speed of 60-120 rpm.

9. The method of claim 8, wherein a lubricant is applied to the brush.

10. The method of claim 9, wherein the lubricant comprises solid particles having a size of 0.5-10 μm.

11. The method of claim 1, wherein:
the granular abrasive comprises a mixture of a small-diameter particles of 30-75 μm and large-diameter particles of 75-900 μm at a ratio of 1:0.5-2;
the blasting is performed by injecting a mixture of the abrasive and water onto the abrasive onto the surface of the cutting tool at a pressure of 1.0-2.5 bar and at an angle in the range of 45±20 degrees; and
the abrasive has a density of 0.8-1.5 kg/l.

12. The method of claim 11, wherein:
the brushing is performed for 50-200 seconds while at least one of the brush and the cutting tool is being rotated at a speed of 60-120 rpm;
a lubricant is applied to the brush; and
the lubricant comprises solid particles having a size of 0.5-10 μm.

13. The method of claim 1, wherein:
the brushing is conducted while simultaneously rotating both the brush and a carrier on which the cutting tool is placed.

14. The method of claim 13, wherein:
the carrier rotates in a first direction for 25-100 seconds, and rotates in a second direction for 25-100 seconds.

15. The method of claim 14, wherein:
the granular abrasive comprises a mixture of a small-diameter particles of 30-75 μm and large-diameter particles of 75-900 μm at a ratio of 1:0.5-2;
the blasting is performed by injecting a mixture of the abrasive and water onto the abrasive onto the surface of the cutting tool at a pressure of 1.0-2.5 bar and at an angle in the range of 45±20 degrees; and
the abrasive has a density of 0.8-1.5 kg/l.

16. The method of claim 15, wherein:
the brushing is performed for 50-200 seconds while at least one of the brush and the carrier is being rotated at a speed of 60-120 rpm;
a lubricant is applied to the brush; and
the lubricant comprises solid particles having a size of 0.5-10 μm.

17. A cutting tool whose surface is treated by the method according to claim 1.

18. A cutting tool whose surface is treated by the method according to claim 13.
